(19) United States
(12) Patent Application Publication
(10) Pub. No.: US 2013/0061871 A1
(43) Pub. Date: Mar. 14, 2013

(54) PLASMA PURGING AN IDLE CHAMBER TO REDUCE PARTICLES

(71) Applicants: David Henry Collins, Delmar, NY (US); Carl Kenneth Elliott, Garland, TX (US)

(72) Inventors: David Henry Collins, Delmar, NY (US); Carl Kenneth Elliott, Garland, TX (US)

(73) Assignee: Texas Instruments Incorporated, Dallas, TX (US)

(21) Appl. No.: 13/560,837

(22) Filed: Jul. 27, 2012

Related U.S. Application Data
(60) Provisional application No. 61/532,834, filed on Sep. 9, 2011.

(51) Int. Cl. B08B 7/00; B08B 13/00

(52) U.S. Cl. 134/1.1; 156/345.26

(57) ABSTRACT

During each idle period in which a plasma processing tool is not used in succession, upon lapse of a selected period of inactivity by the plasma production tool of between 10 and 60 minutes, a plasma is generated within the plasma processing tool to heat the vacuum enclosure to an operating temperature reached during production use of the plasma processing tool. A gas-only purge is then performed, and the vacuum enclosure is pumped down to a base vacuum to remove small particles of less than 0.12 microns that may otherwise generate on the interior walls of the vacuum enclosure. Extended operation of the plasma processing tool without failure of particle qualification or reduced availability is achieved.

### CROSS-REFERENCE TO RELATED APPLICATIONS

This application claims priority to U.S. Provisional Patent Application Ser. No. 61/532,834 filed on Sep. 9, 2011. The content of the above-identified patent document is incorporated herein by reference.

### TECHNICAL FIELD

The present application relates generally to plasma tools used in integrated circuit fabrication and, more specifically, to reducing undesirable particles within a vacuum chamber for such a plasma tool.

### BACKGROUND

Plasma processing chambers are “qualified” before operation in production based on measurement of the number of particles above a specified size (e.g., 0.10 to 0.12 microns) present inside the vacuum chamber. Undesirable particles within a plasma processing tool may lead to fabrication defects during semiconductor integrated circuit manufacture, reducing yield and resulting in higher manufacturing costs per finished integrated circuit chip. Thin film production chambers are particularly susceptible to reduced yield in manufactured chips due to particles, even when smaller than the qualification size. Such particles are due, for example, to gases trapped in the gas lines or inlets of the plasma processing tool. During idle periods between uses of the plasma processing chamber to operate on lots of wafers, the chamber may experience increases in particles below the qualification measurement size that, over time, induces qualification failure.

### SUMMARY

During each idle period in which a plasma processing tool is not used in succession, upon lapse of a selected period of inactivity by the plasma production tool (such as about between about 10 minutes and about 60 minutes), a plasma is generated within the plasma processing tool to heat the vacuum enclosure to an operating temperature reached during production use of the plasma processing tool. A gas-only purge is then performed, and the vacuum enclosure is pumped down to a base vacuum to remove small particles of less than a specified size (such as less than about 0.12 microns) that may otherwise generate on the interior walls of the vacuum enclosure. Extended operation of the plasma processing tool without failure of particle qualification or reduced availability is achieved.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a plasma processing tool employing plasma purging during idle periods, as well as gas purging, to reduce particles according to one embodiment of the present disclosure;

FIG. 2 is a scatter graph illustrating change in particle count over time within an idle plasma processing tool when gas purging is employed with and without plasma idle purging according to the present disclosure; and

FIG. 3 is a high level flow diagram for an idle period plasma purging process to reduce particles according to one embodiment of the present disclosure.

### DETAILED DESCRIPTION

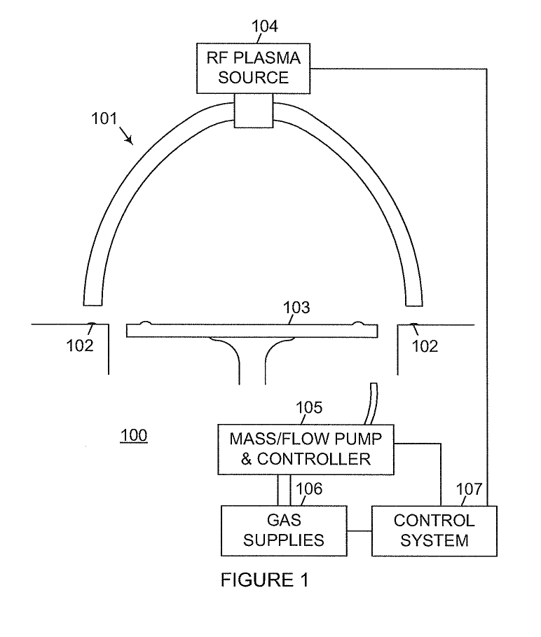

FIGS. 1 through 3, discussed below, and the various embodiments used to describe the principles of the present disclosure in this patent document are by way of illustration only and should not be construed in any way to limit the scope of the disclosure.

Particle reduction for idle plasma process chambers may utilize a “gas purge” based on a series of gas introductions to increase pressure, followed by turning off the gas and pumping to a low vacuum to evacuate the chamber. The mechanism by which particle reduction is effected involves eliminating gases that can become trapped in the gas lines, leading to particle issues. The above-described method may be applied across a wide variety of chamber types for different tool types and systems manufactured by different vendors but has been determined by the inventors to result in varying success in reducing particles.

FIG. 1 illustrates a plasma processing tool 100 employing plasma purging during idle periods, as well as gas purging, to reduce particles according to one embodiment of the present disclosure. Plasma processing tool 100 includes a vacuum chamber 101 defined by a dome that may be selectively clamped to a chamber base including seals 102, forming a vacuum enclosure. Within the vacuum chamber 101 is a wafer chuck 103 for supporting a wafer to be operated on using the plasma processing tool 100. Plasma processing tool 100 may represent a high density plasma (HDP) processing system and may be used, for example, to deposit inter-metal dielectric (IMD) layers on integrated circuits or for oxide depositions.

Plasma processing tool 100 includes a plasma source 104 configured to produce a plasma (ionized gas) of a selected material, to introduce the plasma into the vacuum chamber 101 while the interior of the chamber is otherwise substantially evacuated, and to direct a beam of such plasma onto a wafer supported on the wafer chuck 103. In the exemplary embodiment, plasma source 104 is a radio frequency (RF) plasma device. Plasma processing tool 100 also includes a gas mass/flow pump and controller 105 configured to selectively evacuate the vacuum chamber 101 or to introduce selected gases into the vacuum chamber 101 in a controlled manner. Mass/flow pump and controller 105 is thus in fluid communication with one or more gas supplies 106, each containing a source of gas with a predetermined purity. The gases employed may include oxygen (O₂) or inert gases such as argon (Ar). The plasma source 104, mass/flow pump and controller 105, and inlet control valves connected to gas supplies 106 are electrically coupled to and controlled by a user-programmable control system 107, which controls the sequence of operation of those subsystems and the parameters of their operation.

Those skilled in the art will recognize that the complete structure and operation of a plasma processing tool is not depicted in the drawings or described herein. Instead, for simplicity and clarity, only so much of a plasma processing tool as is unique to the present disclosure or necessary for an understanding of the present disclosure is depicted in the drawings and described herein. In addition, at least some of the components of the plasma processing tool are illustrated diagrammatically in the drawings, without intending to suggest the physical structure or location of those components within the plasma processing tool.

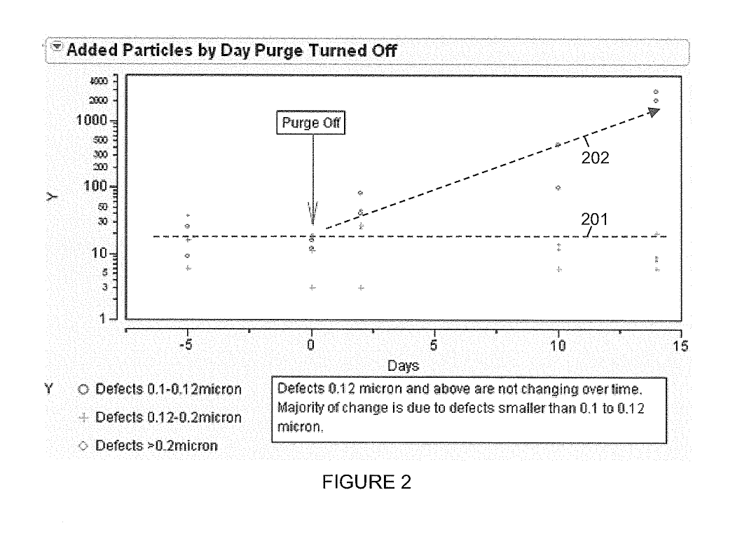

FIG. 2 is a scatter graph illustrating change in particle count over time within an idle plasma processing tool when gas purging is employed with and without plasma idle purging according to the present disclosure. The abscissa of the plot is time, while the logarithmic ordinate is the particle count. Particles of different sizes are identifies by different plot markers. The circles represent a count of defects or particles having a size of 0.10 to 0.12 microns (μm), the crosses represent a count of defects or particles having a size of 0.12 to 0.20 μm, and the diamonds represent a count of defects or particles having a size greater than 0.20 μm.

As illustrated in FIG. 2, a baseline 201 established by performing plasma purging along with gas purging exhibited particle counts for all three of the above-defined size ranges to remain below about 20. A comparative trend 202 for measurements taken after plasma purging was stopped at time 0 reflects a significant increase over time for particles between 0.10 to 0.12 μm, rising two orders of magnitude over about two weeks, despite the count of larger particles remaining at acceptable levels.

FIG. 2 exemplifies the effect observed by the inventors, post maintenance in response to a particle fail, during start-up of a new plasma processing tool. During start-up, the tool kept failing particle qualification, and required reactive maintenance every 72 hours to allow the tool to pass qualification. Seasoning with a season or “burn” wafer every 4 hours seemed to provide a little benefit, but the availability of the tool for production use remained at an average of 15% lower due to increased maintenance.

It was determined by the inventors that the temperature of the vacuum chamber dome was not being exercised frequently enough when the tool was idle and subject to only gas purging. That lack of temperature excursion allowed the count of very small particles, of about 0.1 to 0.12 μm (below typical qualification measurement), to increase within 72 hours to a level that would induce a qualification failure.

The solution of the present disclosure adds the use of a plasma to improve upon the existing gas purging by adding a temperature component (created by the plasma) to prevent particle generation on the dome and walls. A standard gas purge is then performed to take the particles out of the chamber through the foreline. Then a pump-down to base vacuum is employed to ensure all gases and particles have been removed from the vacuum chamber. This combination of periodic temperature cycling and gas purges works to improve the chamber idle condition. After implementation of the above-described solution, an immediate improvement was seen without the need for a periodic “burn” wafer.

The effectiveness of particle reduction has been found to be keyed to adding the plasma purge prior to gas purge/pump cycles. Gas-only purges (i.e., without a plasma purge as described) are designed to reduce the risk of gases trapped in the gas lines leading to a particle problem. Such purges are not designed to reduce particle issues related to the vacuum chamber components, which drives the need for season or “burn” wafers.

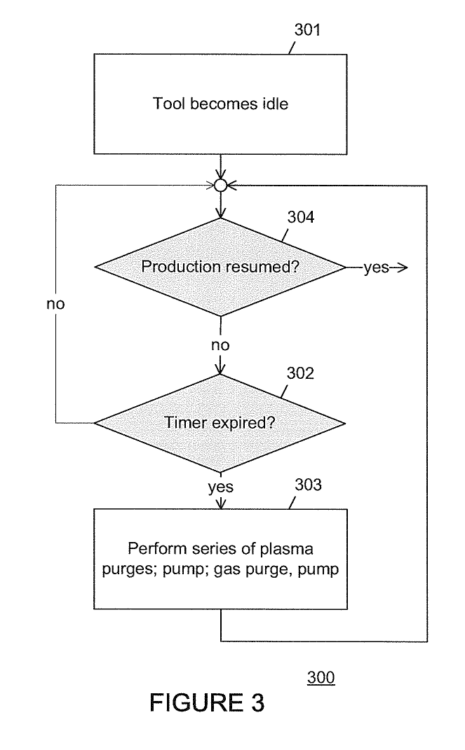

FIG. 3 is a high level flow diagram for an idle period plasma purging process 300 to reduce particles according to one embodiment of the present disclosure. The process 300 is performed by a programmed plasma processing tool of the type depicted in FIG. 1 or in any similar plasma processing tool. The process 300 begins with the tool becoming idle (step 301) and not needed to operate on wafers during a current production run. A time period during which no activity occurs in the plasma processing tool elapses (step 302). The defined period of inactivity may be anywhere, such as from about 10 minutes to about 60 minutes.

Upon expiration of the selected period of inactivity, a series of plasma purges is initiated (step 303). The plasma processing tool is activated to produce a plasma (e.g., inert gas flow, followed by O₂ flow, and then RF plasma generation). The mechanism for directing a beam of plasma at the wafer chuck need not be activated, since a goal of plasma production is merely to heat the vacuum chamber dome, which can cause particles adhering to the chamber's interior walls to dissociate from the walls. The chamber is then pumped down to base vacuum, followed by a gas only purge and then by a second pump down to base vacuum, to remove any free (or loose) particles from the chamber. The sequence may be repeated multiple times in succession before the tool is allowed to once again become inactive, awaiting expiration of the selected inactivity period (step 302). The process may continue for as long as the tool remains idle. Upon resumption of production with the tool, the process exits the loop depicted (step 304).

The addition of a thermal component (plasma purging) to idle period preventive maintenance in plasma processing tools has been proven to keep small particles from increasing due to idle periods. A chamber was run with the above-described plasma purging in addition to gas purging for more than six months without qualification failure. Turning off the plasma purging led to catastrophic failure within three days, similar to the timing of such failures seen at tool start-up with reactive maintenance in response to particle fails.

The following definitions apply to certain words and phrases used throughout this patent document: the terms “include” and “comprise,” as well as derivatives thereof, mean inclusion without limitation; the term “or,” is inclusive, meaning and/or; and the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for other words and phrases are provided throughout this patent document, those of ordinary skill in the art should understand that in many, if not most instances, such definitions apply to prior, as well as future uses of such defined words and phrases.

Although the present disclosure has been described with exemplary embodiments, various changes and modifications may be suggested to one skilled in the art. It is intended that the present disclosure encompass such changes and modifications as fall within the scope of the appended claims.

What is claimed is:

1. A method, comprising:
periodically during an idle period in which a plasma processing tool is not used for production:
generating a plasma within a vacuum enclosure of the plasma processing tool,
initiating a gas-only purge of the vacuum enclosure, and pumping the vacuum enclosure down to a base vacuum.

2. The method of claim 1, wherein the plasma is generated for a period sufficient to heat the vacuum enclosure to an operating temperature reached during production using the plasma processing tool.

3. The method of claim 2, wherein plasma generation is repeatedly initiated and terminated, with intervening times during which plasma is not generated, during the period.

4. The method of claim 1, further comprising:
pumping the vacuum enclosure down to the base vacuum between generating the plasma and initiating the gas-only purge.

5. The method of claim 4, wherein a sequence of generating the plasma, pumping the vacuum enclosure down to the base vacuum, initiating the gas-only purge, and pumping the vacuum enclosure down to a base vacuum is repeated at least twice in succession.

6. The method of claim 1, wherein the gas-only purge comprises flowing an inert gas through the vacuum enclosure.

7. The method of claim 1, wherein generating the plasma comprises generating the plasma without directing a beam of the plasma toward a wafer chuck within the vacuum enclosure at any time during generation of the plasma.

8. The method of claim 7, wherein a periodicity for generating the plasma during the idle period is every 10 to 60 minutes.

9. A plasma processing tool, comprising:
a vacuum enclosure;
a mass/flow system configured to selectively flow one or more selected gasses through the vacuum enclosure and to selectively pump the vacuum chamber down to a base vacuum;
a plasma source configured to generate a plasma within the vacuum enclosure; and
a control system configured to control operation of the mass/flow system and the plasma source, the control system configured to, periodically during an idle period in which a plasma processing tool is not used for production:
generate a plasma within the vacuum enclosure,
initiate a gas-only purge of the vacuum enclosure, and
pump the vacuum enclosure down to the base vacuum.

10. The plasma processing tool of claim 9, wherein the control system is configured to generate the plasma for a period sufficient to heat the vacuum enclosure to an operating temperature reached during production using the plasma processing tool.

11. The plasma processing tool of claim 10, wherein the control system is configured to repeatedly initiate and terminate generation of the plasma, with intervening times during which plasma is not generated, during the period.

12. The plasma processing tool of claim 9, wherein the control system is configured to pump the vacuum enclosure down to the base vacuum between generating the plasma and initiating the gas-only purge.

13. The plasma processing tool of claim 12, wherein the control system is configured to repeat a sequence of generating the plasma, pumping the vacuum enclosure down to the base vacuum, initiating the gas-only purge, and pumping the vacuum enclosure down to a base vacuum at least twice in succession.

14. The plasma processing tool of claim 9, wherein the gas-only purge comprises flowing an inert gas through the vacuum enclosure.

15. The plasma processing tool of claim 9, wherein generating the plasma comprises generating the plasma without directing a beam of the plasma toward a wafer chuck within the vacuum enclosure at any time during generation of the plasma.

16. The plasma processing tool of claim 15, wherein a periodicity for generating the plasma during the idle period is every 10 to 60 minutes.

17. A method, comprising:
generating a plasma within a vacuum enclosure of the plasma processing tool;
pumping the vacuum enclosure down to a base vacuum after generating the plasma;
initiating a gas-only purge of the vacuum enclosure after pumping the vacuum enclosure down to a base vacuum; and
pumping the vacuum enclosure down to a base vacuum after initiating the gas-only purge.

18. The method of claim 17, wherein generating the plasma further comprises:
generating the plasma for a period sufficient to heat the vacuum enclosure to an operating temperature reached during production using the plasma processing tool.

19. The method of claim 17, wherein generating the plasma further comprises:
generating the plasma for a first period;
allowing a second period to elapse without generating the plasma; and
generating the plasma after allowing the second period to elapse.

20. The method of claim 17, further comprising:
repeating a sequence of generating the plasma, pumping the vacuum enclosure down to the base vacuum, initiating the gas-only purge, and pumping the vacuum enclosure down to the base vacuum at least twice during an idle period in which the plasma processing tool is not used for production.
